(19) United States
(12) Patent Application Publication
(10) Pub. No.: US 2026/0275800 A1
(43) Pub. Date: Sep. 17, 2026

(54) System and Method for Constructing Window and Door Frames

(71) Applicant: Everest Shpk, Tirana (AL)

(72) Inventor: Albert Valteri, Tirana (AL)

(21) Appl. No.: 19/076,051

(22) Filed: Mar. 11, 2025

(51) Int. Cl. E06B 3/26; E06B 3/96

(52) U.S. Cl. CPC E06B 3/26; E06B 3/9608

(57) ABSTRACT

A method of producing a frame unit. A first elongate beam, extending outwardly of a first exterior plate, is slid into a first elongate channel of an internal segment. Two opposing walls of the first elongate channel are compressed against the first elongate beam, in a direction perpendicular to a longitudinal axis of the first elongate channel. The first exterior plate is adhered to the internal segment by heating the first exterior plate and the internal segment until the internal segment is pliably deformed and subsequently cooling the first exterior plate and the internal insert to ambient temperature. The first exterior plate is formed of a first material, and the internal segment is formed of a second material, different from the first material.

### FIELD OF THE DISCLOSED TECHNOLOGY

The disclosed technology relates generally to frames, and, more specifically, to systems and methods for constructing window and door frames from multiple materials, taking the advantages of each of the materials.

### BACKGROUND OF THE DISCLOSED TECHNOLOGY

In the field of architectural design and construction, there is great demand for window frames that offer enhanced functionality, durability, and energy efficiency. Traditional window frames, typically made from wood, aluminum, or uPVC, have served this purpose well but often present limitations that can affect overall building performance and user satisfaction.

Wooden frames, while aesthetically pleasing and versatile, are susceptible to issues such as warping, rotting, and high maintenance requirements due to their vulnerability to environmental elements. Aluminum frames, known for their strength and resistance to corrosion, often suffer from poor thermal insulation properties, leading to energy inefficiency and discomfort within indoor environments. uPVC frames, although offering improved insulation and lower maintenance, can face challenges related to environmental impact, structural limitations, and aesthetic constraints.

Attempts to construct an ideal window frame have led to the exploration of innovative materials and designs that address these shortcomings. Recent advancements have introduced composite materials that attempt to combine the benefits of traditional materials while mitigating their drawbacks. However, there remains a significant need for novel constructions and methods of integration of multiple materials in order to fully realize the potential offered by utilization of multiple building materials concurrently.

### SUMMARY OF THE DISCLOSED TECHNOLOGY

The present disclosure relates generally to frames, and, more specifically, to systems and methods for constructing window and door frames from multiple materials, taking the advantages of each of the materials.

The disclosed technology relates to a window or door frame that incorporates multiple materials, to gain the benefits of each material. The disclosed frame integrates composite materials with a multi-layer construction technique, which offers superior thermal insulation, enhanced durability, and reduced environmental impact. The frame's design features a modular assembly system that simplifies installation and maintenance, while its customizable aesthetic options cater to a wide range of architectural styles.

In accordance with an embodiment of the disclosed technology, there is provided a method of producing a frame unit. The method includes sliding a first elongate beam, extending outwardly of a first exterior plate, into a first elongate channel of an internal segment. The method further includes compressing two opposing walls of the first elongate channel against the first elongate beam in a direction perpendicular to a longitudinal axis of the first elongate channel, thereby reducing a distance between the two walls of the first elongate channel. The method further includes adhering the first exterior plate to the internal segment by heating the first exterior plate and the internal segment until the internal segment is pliably deformed and subsequently cooling the first exterior plate and the internal insert to ambient temperature.

In some embodiments, the first exterior plate is formed of a first material, and the internal segment is formed of a second material, different from the first material.

In some embodiments, the method further includes sliding a second elongate beam, extending outwardly of a second external plate, into a second elongate channel of the internal segment. In some embodiments, the method further includes compressing two walls of the second elongate channel against the second elongate beam in a direction perpendicular to a longitudinal axis of the second elongate channel, thereby reducing a distance between the two walls of the second elongate channel. In some embodiments, the method further includes adhering the second exterior plate to the internal segment by heating the second exterior plate and the internal insert until the internal segment is pliably deformed and subsequently cooling the second exterior plate and the internal insert to ambient temperature.

In some embodiments, the compressing includes applying pressure to the two walls of the first elongate channel by rolling a first roller of a pair of rollers along a first side of the first elongate channel, and a second roller of the pair of rollers along a second opposing side of the first elongate channel.

In some embodiments, the compressing includes applying pressure to the two walls of the first elongate channel rolling a first roller of a pair of rollers along a first side of the first elongate channel, and a second roller of the pair of rollers along a second opposing side of the first elongate channel, and applying pressure to the two walls of the second elongate channel rolling the first roller of the pair of rollers along a first side of the second elongate channel, and the second roller of the pair of rollers along a second opposing side of the second elongate channel.

In some embodiments, the compressing includes applying pressure to the two walls of the first elongate channel rolling a first roller of a first pair of rollers along a first side of the first elongate channel, and a second roller of the first pair of rollers along a second opposing side of the first elongate channel and simultaneously applying pressure to the two walls of the second elongate channel rolling a first roller of a second pair of rollers along a first side of the second elongate channel, and a second roller of the second pair of rollers along a second opposing side of the second elongate channel.

In some embodiments, following the compressing, the first exterior plate and the second exterior plate are frictionally held in place with respect to the internal segment by static friction of the first and second elongate beams against the respective first and second elongate channels.

In some embodiments, following the compressing, the first exterior plate is substantially perpendicular to the internal segment, and the second exterior plate is substantially perpendicular to the internal segment and substantially parallel to the first exterior plate.

In some embodiments, the adhering includes heating the first exterior plate and the internal segment to a temperature greater than at least one of a glass transition temperature and a melting temperature of the second material and lesser than the melting point of the first material.

In some embodiments, the sliding further includes sliding side walls of the first elongate channel into a first pair of elongate channels, each of the first pair of elongate channels separating the first elongate beam from one of a first pair of elongate walls, the first pair of elongate walls extending outwardly from the first plate on opposing sides of the first elongate beam, and the compressing includes pushing the first pair of elongate walls closer to one another.

In some embodiments, following the compressing, each of the first pair of elongate walls are compressed against the side walls of the first elongate channel, such that each of the side walls of the first elongate channel is frictionally engaged by the first elongate beam and by one of the first pair of elongate walls.

There is further provided, in accordance with embodiments of the disclosed technology, a method of producing a frame using a plurality of frame units produced as described herein. The method includes diagonally cutting each the frame unit to form two trapezoidal faces, each having a set of parallel edges and at least one sloping edge not perpendicular thereto, and at least one sloping face sharing edges with the trapezoidal faces, all sloping faces being isometric, and abutting the entirety of a sloping face of each of the frame units to the entirety of a sloping face of at least one adjacent frame unit, thereby to form at least one contiguous internal hollow bounded by and enclosed within every the internal insert.

There is additionally provided, in accordance with embodiments of the disclosed technology, a frame unit including first and second exterior plates, each having an elongate beam extending outwardly therefrom, the first and second exterior plates being formed of a first material, and an internal segment having two elongate channels formed in opposing sides thereof, each of the two elongate channels having one of the elongate beams frictionally secured therein, the internal segment being formed of a second material, different from the first material. In some embodiments, a portion of the internal segment is adhered to each of the first and second exterior plates by heating the frame unit to the glass transition point and/or the melting point of the second material and subsequently allowing the frame unit to cool.

In some embodiments, each of the first and second elongate plates further has a pair of elongate walls extending outwardly therefrom on opposing sides the respective elongate beams, each elongate wall of the pair of elongate walls being separated from the respective elongate beam by elongate a secondary elongate channels and side walls of each of the elongate channels are frictionally engaged within the secondary elongate channels of the first and second plates.

In some embodiments, the first material is a metal, a metalloid, or a metal-alloy and the second material is a plastic polymer having a lower melting point and/or glass transition temperature than the first material. In some embodiments, the first material is aluminum and the second material is polyvinyl chloride (PVC).

In some embodiments, each elongate channel has two congruent openings disposed at opposing ends of the elongate channel, each the opening having two acute angles, each acute angle formed between two edges bounding the respective opening.

In some embodiments, each elongate channel has an elongate base and an elongate opening opposite the base, the base being closer to a center of the internal segment than the elongate opening, the base being the widest point of the elongate channel.

In some embodiments, the internal segment includes a plurality of hollow internal chambers, at least one hollow internal chamber accommodating a hollow metal support which abuts walls of the at least one hollow internal chamber. In some embodiments, at least a subset of the plurality of the hollowed chambers are equal in width and unequal in height.

In some embodiments, the elongate beams of the first and second plates are congruent, and the two elongate channels are congruent.

### BRIEF DESCRIPTION OF THE DRAWINGS

FIGS. 1A and 1B are schematic illustrations of steps of forming a frame unit for assembly of a frame according to embodiments of the disclosed technology.

FIG. 2 is a schematic illustration of an initial step of connecting frame units assembled using the steps of FIGS. 1A and 1B to form a frame, according to embodiments of the disclosed technology.

FIGS. 3A and 3B are front view illustrations and a sectional illustration of a window having a frame constructed as shown in FIG. 2according to embodiments of the disclosed technology.

FIGS. 4A and 4B are front view illustrations and a sectional illustration of another window having a frame constructed as shown in FIG. 2 according to embodiments of the disclosed technology.

FIGS. 5A and 5B are front view illustrations and a sectional illustration of a door having a frame constructed as shown in FIG. 2 according to embodiments of the disclosed technology.

### DETAILED DESCRIPTION OF EMBODIMENTS OF THE DISCLOSED TECHNOLOGY

The disclosed technology relates to a window or door frame that incorporates multiple materials, to gain the benefits of each material. The disclosed frame integrates composite materials with a multi-layer construction technique, which offers superior thermal insulation, enhanced durability, and reduced environmental impact. The frame's design features a modular assembly system that simplifies installation and maintenance, while its customizable aesthetic options cater to a wide range of architectural styles.

In an embodiment of the disclosed technology, a frame unit includes first and second exterior plates, each having an elongate beam extending outwardly therefrom, the first and second exterior plates being formed of a first material, and an internal segment having two elongate channels formed in opposing sides thereof, each of the two elongate channels having one of the elongate beams frictionally secured therein, the internal segment being formed of a second material, different from the first material. In some embodiments, a portion of the internal segment is adhered to each of the first and second exterior plates by heating the frame unit to the glass transition point and/or the melting point of the second material and subsequently allowing the frame unit to cool.

Embodiments of the disclosed technology will become clearer in view of the following description of the drawings.

In the context of the present specification and claims, the term “approximately” is defined as being within 10% of a target number or measure.

For purposes of this disclosure, the term “substantially” is defined as “at least 95% of” the term which it modifies.

When the term “or” is used, it creates a group which has within either term being connected by the conjunction as well as both terms being connected by the conjunction.

It should be understood that the use of “and/or” is defined inclusively such that the term “a and/or b” should be read to include the sets: “a and b,” “a or b,” “a,” “b.”

Any device or aspect of the technology can “comprise” or “consist of” the item it modifies, whether explicitly written as such or otherwise.

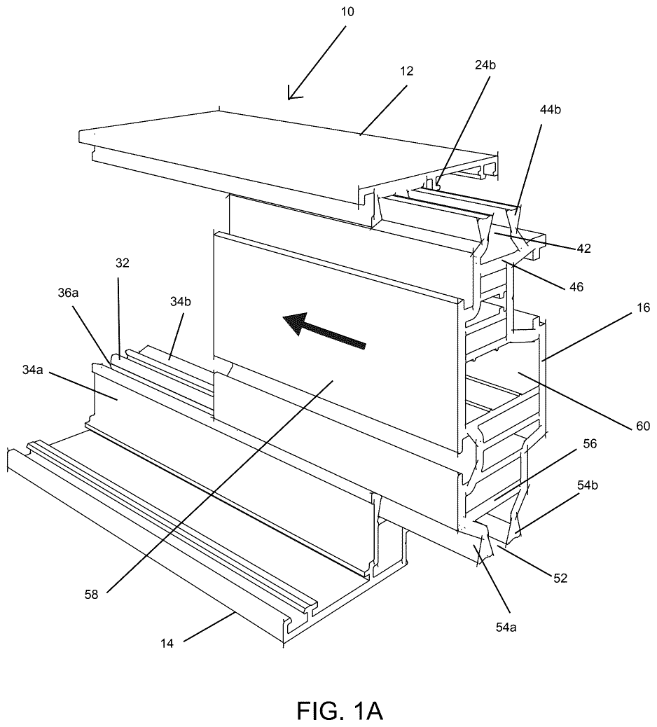

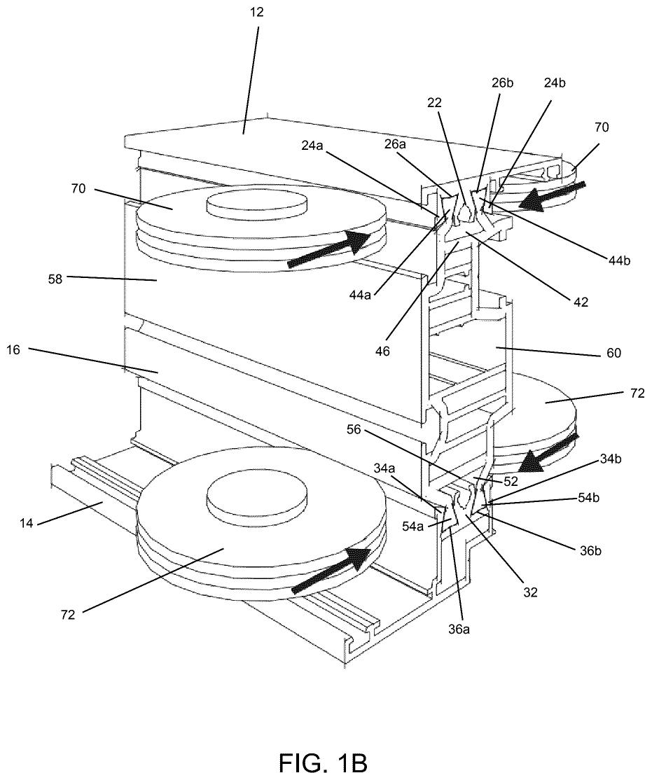

FIGS. 1A and 1B are schematic illustrations of steps of forming a frame unit, or profile, for assembly of a frame according to embodiments of the disclosed technology.

As seen in FIGS. 1A and 1B, the frame unit 10 includes a first exterior plate 12, a second exterior plate 14, and an internal segment 16.

First exterior plate 12 has a first elongate beam 22 extending outwardly therefrom. In some embodiments, two elongate walls 24a and 24b extend outwardly from plate 12 on opposing sides of beam 22, the elongate walls being separated from prismatic beam 22 by elongate channels 26a and 26b, respectively. In some embodiments, beam 22 is prismatic, and has a consistent cross section along the entire length thereof. In some embodiments, walls 24a and 24b are parallel to each other. In some embodiments, walls 24a and 24b are parallel to beam 22.

Second exterior plate 14 has a second elongate prismatic beam 32 extending outwardly therefrom. In some embodiments, two elongate walls 34a and 34b extend outwardly from plate 14 on opposing sides of beam 32, the elongate walls being separated from prismatic beam 32 by elongate channels 36a and 36b, respectively. In some embodiments, beam 32 is prismatic, and has a consistent cross section along the entire length thereof. In some embodiments, walls 34a and 34b are parallel to each other. In some embodiments, walls 34a and 34b are parallel to beam 32.

In some embodiments, beam 22 and walls 24a and 24b integrally formed with first exterior plate 12, and beam 32 and walls 34a and 34b integrally formed with second exterior plate 14. In some embodiments, plates 12 and 14, as well as beams 22 and 32, are formed of a metal, a metalloid, or a metal alloy. In some embodiments, plates 12 and 14, as well as beams 22 and 32, may be formed of aluminum. In some embodiments, the aluminum may have a density of 2.5-3.0 grams per cubic centimeter and a melting point in the range of 650 to 700 degrees Celsius.

In some embodiments, plates 12 and 14 are congruent, and/or beams 22 and 24 are congruent.

Internal segment 16 includes a first channel 42 defined by a pair of walls 44a and 44b and a base 46, and a second channel 52 defined by a pair of walls 54a and 54b and a base 56. In some embodiments, channels 42 and 52 are formed at opposing ends of internal segment 16. In some embodiments, walls 44a and 44b are parallel to each other, along the length thereof. In some embodiments, walls 54a and 54b are parallel to each other, along the length thereof.

In some embodiments, at least one of, or each of, channels 42 and 52 has a substantially trapezoidal cross-section in a direction perpendicular to the length of the channel. In some embodiments, each of walls 44a and 44b forms an acute angle with base 46, such that an opening of channel 42 is narrower than the base thereof. In some embodiments, and as shown, the opening of channel 42 is further from the center of internal segment 16 than base 46. In some embodiments, each of walls 54a and 54b forms an acute angle with base 56, such that an opening of channel 52 is narrower than the base thereof. In some embodiments, and as shown, the opening of channel 52 is further from the center of internal segment 16 than base 56.

In some embodiments, channels 42 and 52 are congruent.

In some embodiments, side walls 58a and 58b of internal segment 16 are asymmetrical, and may include additional slots, channels, and/or protrusions.

Typically, one or more hollow chambers 60 are formed between side walls 56a and 56b of internal segments. In some embodiments, hollow chambers 60 may accommodate structural reinforcement elements, as explained in further detail hereinbelow. In some embodiments, two different hollow chambers 60a and 60b may have the same width and different heights.

In some embodiments, internal segment 16 is formed of a plastic polymer, such as polyvinyl chloride (PVC). In some embodiments, the plastic polymer of internal segment 16 has a lower melting point and/or a lower glass transition temperature than a melting temperature of the metal from which plates 12 and 14 are formed.

As seen in FIGS. 1A and 1B, frame unit 10 is formed by sliding beam 22 of exterior plate 12 into channel 42 of internal segment 16, and sliding beam 32 of exterior plate 14 into channel 52 of internal segment 16. In some embodiments, walls 44a and 44b of channel 42 are accommodated within channels 26a and 26b of first plate 12, and walls 54a and 54b of channel 52 are accommodated within channels 36a and 36b of second plate 14, respectively.

Subsequently, walls 44a and 44b of channel 42 and walls 54a and 54b of channel 52 are compressed against beam 12 and 14 respectively, in a direction perpendicular to the walls. This reduces the width of channels 42 and 52, respectively, allowing for greater friction between the beams and the channels in which they are accommodated.

In some embodiments, the compression of the walls of channels 42 and 52 may be accomplished using rollers, as illustrated in FIG. 1B. In some embodiments, a first pair of rollers 70 is adapted to compress the walls of channel 42, and a second pair of rollers 72 is adapted to compress the walls of channel 52, for example concurrently with operation of rollers 70. In some embodiments, the compression of the walls of channels 42 and 52 may be carried out using a single pair of rollers, in sequence.

In some embodiments, and as illustrated, the compression of walls 44a and 44b may be carried out by rollers 70 applying pressure to walls 24a and 24b of first plate 12, which flank walls 44a and 44b of channel 42. Similarly, the compression of walls 54a and 54b may be carried out by rollers 72 applying pressure to walls 34a and 34b of second plate 14, which flank walls 54a and 54b of channel 52.

Typically, following compression of the walls of channels 42 and 52, beams 22 and 32 are frictionally held in place with respect to internal segment 16, for example by static friction of the beams against the respective channels in which they are accommodated. In some embodiments, walls 44a and 44b of channel 42 and walls 54a and 54b of channel 52 are frictionally held in place with respect to each of plates 12 and 14, respectively, for example by static friction of the walls against respective channels 26a, 26b, 36a, and 36b in which the walls are accommodated.

In some embodiments, following compression of the walls of channels 42 and 52, plates 12 and 14 together with internal segment 16 are heated to a temperature in which the internal segment is pliably deformed, and then cooled to ambient temperature. This heating and cooling process assists in adhering the first and second plates to the internal segment. In some embodiments, the temperature is greater than the glass transition temperature and/or greater than the melting point of the material from which internal segment 16 is formed, but lesser than the melting point of first exterior plate 12 and/or of second exterior plate 14.

In some embodiments, in the resulting frame unit, first and second plates 12 and 14 are substantially parallel to each other, and are each substantially perpendicular to side walls 58 of internal segment 16.

In some embodiments, reinforcement beams, such as hollow steel profiles, are inserted into one or more of hollow chambers 60 of internal segment 16 and abut against walls of the chambers.

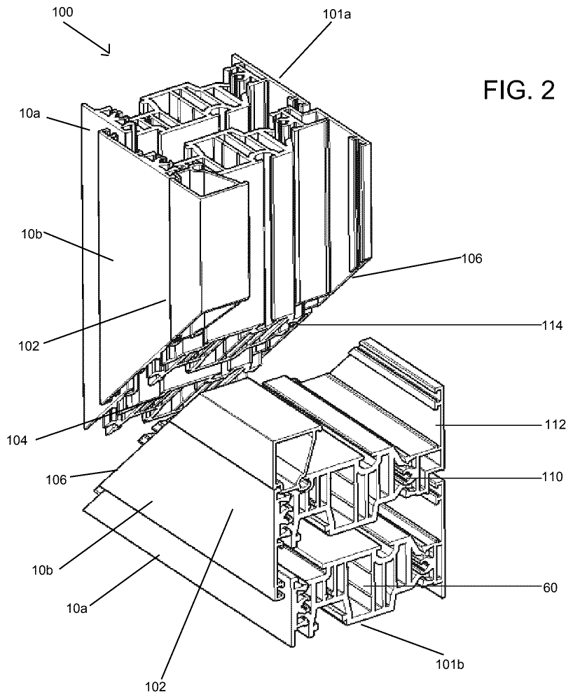

FIG. 2 is a schematic illustration of a step of connecting frame units assembled using the steps of FIGS. 1A and 1B, to form a frame 100, according to embodiments of the disclosed technology.

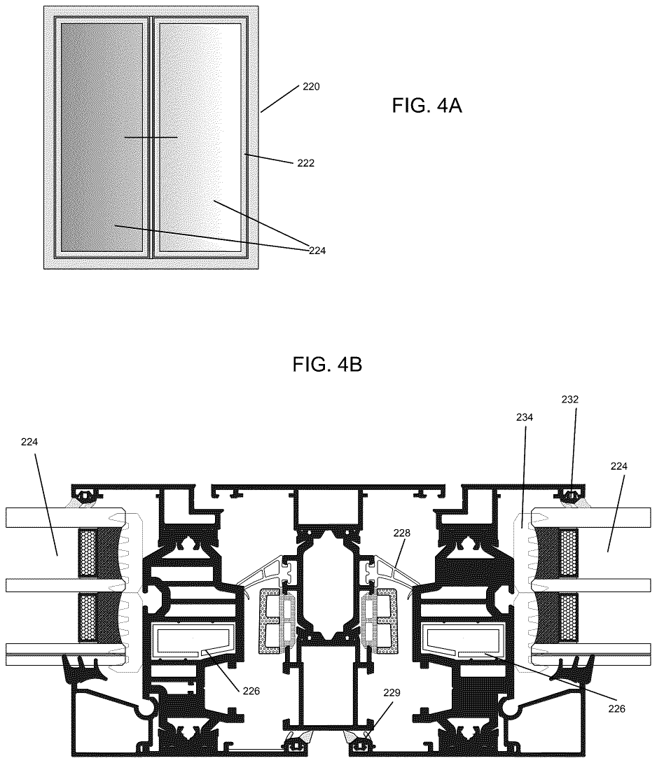

It is to be appreciated that FIG. 2 shows a frame formed of a first pair of frame units 10a, which are connected to each other to form a first profile 101a, and a second pair of frame units 10b, which are connected to each other to form a second profile 101b. As shown, the first profile 101a forms a first side of the frame, and the second profile 101b forms a second side of the frame, perpendicular to the first side. However, frames can be formed also from single frame units, not pairs of frame units, as shown for example in FIG. 4B.

As seen in FIG. 2, each of profiles 101a and 101b is cut diagonally to form trapezoidal side faces 102 for each of the profiles. Trapezoidal side faces 102 are each formed from trapezoidal sections of each of plates 12 and 14 of the first and second pairs of frame units 10a and 10b. As a result, a sloping face 104 connects the trapezoidal side faces 102, and shares sharing sloping edges 106 therewith. In some embodiments, sloping edges 106 are disposed at an acute angle to the longitudinal axis of each of beams 22 and 32.

In some embodiments, the cutting of profiles 101a and 101b is accomplished by milling of plates 12 and 14 and/or of internal segments 16 of each of the frame unit pairs forming the profile.

Sloping faces 104 of profiles 101a and 101b are placed alongside each other and are pushed to abut each other, such that a right angle is formed by trapezoidal side faces 102 both at an exterior of the structure and at the interior thereof, thereby to form a corner of frame 100.

The attachment of profiles 101a and 101b may be further reinforced by a screw connection 110, for example via one of hollow chambers 60, via use of a corner joint, such as a Fuji corner joint, disposed in slots 112 of portions of plates 12 and/or 14 of the frame units forming the profiles, and or by welding of areas of sloping faces 104 to each other, for example at welding joints 114.

The resulting corner of frame 100 defines a channel suitable for accommodating a window or door pane, as explained in further detail hereinbelow.

Additionally, frame 100 has the insulating characteristics of the PVC from which internal segment 16 is formed, as well as the strength and resistance to corrosion afforded by the metal or exterior plates.

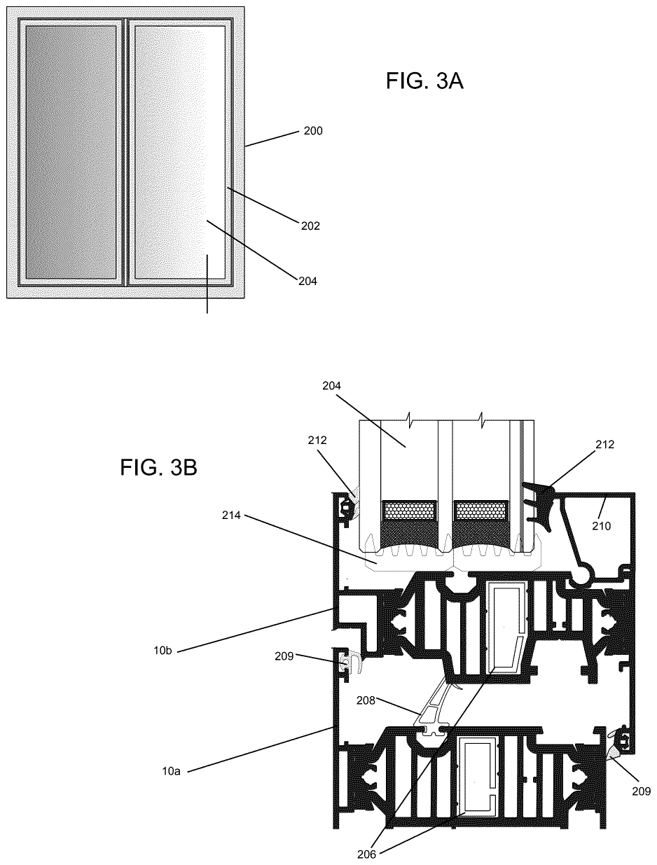

FIGS. 3A and 3B are front view illustrations and a sectional illustration of a window 200 having a frame 202 constructed as shown in FIG. 2 according to embodiments of the disclosed technology.

As seen, frame 202 surrounds a pane 204 of window 200 from all sides.

As seen in FIG. 3B, each side of frame 202 comprises a profile 101 of FIGS. 2A to 2B and includes two frame units 10, each including first and second plates 12 and 14, and internal segment 16. Reinforcing metal profiles 206 extend through hollow chambers 60 in each of the internal segments 16. The internal segments are held together with a plurality of gaskets 208, which may be formed of a monomeric rubber (e.g., EPDM) or of a polymer (e.g., PVC).

An aluminum glass beading 210 is attached to one of frame units 10, and to additional gaskets 212, which in turn engage pane 204, which is illustrated as a double glazing pane.

In some embodiments, an insulating material 214, such as polyethylene foam, is disposed between profile 101 (and specifically an internal segment thereof) and an edge of pane 204.

FIGS. 4A and 4B are front view illustrations and a sectional illustration of another window 220 including two panes 224, each surrounded by a frame 222 constructed as shown in FIG. 2 according to embodiments of the disclosed technology.

As seen in FIG. 4A, a central beam 225 is disposed between panes 224. Additionally, each frame 222 surrounds a pane 224 of window 220 from all sides.

As seen in FIG. 4B, each side of each frame 222 comprises a frame unit 10, each including first and second plates 12 and 14, and internal segment 16. Reinforcing metal profiles 226 extend through hollow chambers 60 in each of the internal segments 16. The internal segments of frames 222 can engage central beam 225 with gaskets 228, which may be formed of a monomeric rubber (e.g., EPDM) or of a polymer (e.g., PVC).

An aluminum glass beading 230 is attached to one of frame units 10, and to additional gaskets 232, which in turn engage panes 224, both illustrated as a double glazing panes.

In some embodiments, an insulating material 234, such as polyethylene foam, is disposed between the frame unit 10 (and specifically an internal segment thereof) and an edge of pane 224.

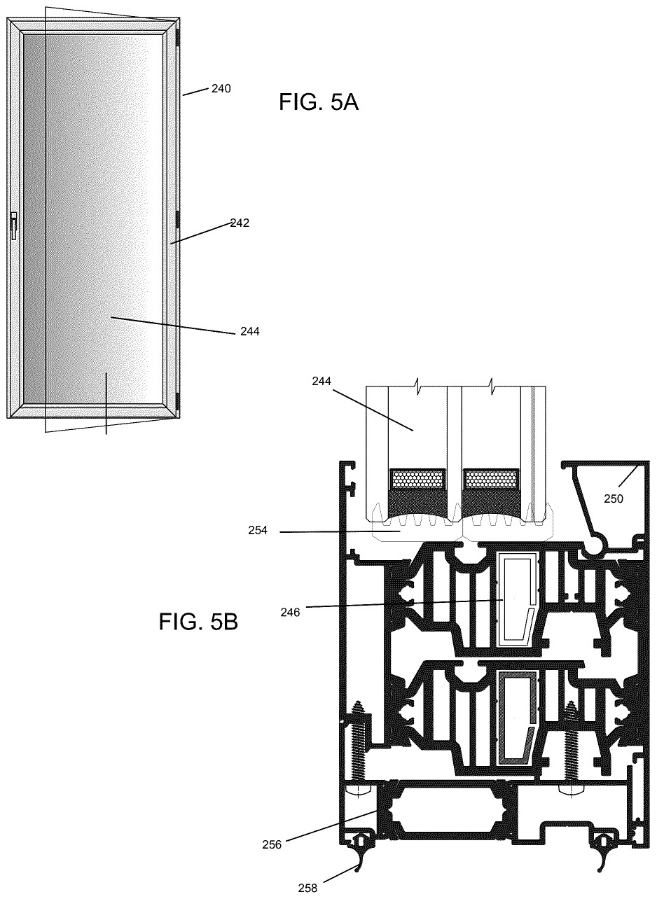

FIGS. 5A and 5B are front view illustrations and a sectional illustration of a door 240 having a frame 242 constructed as shown in FIG. 2 according to embodiments of the disclosed technology.

As seen, frame 242 surrounds a pane 244 of window 240 from all sides.

As seen in FIG. 5B, each side of frame 242 comprises a profile 101 of FIG. 2 and includes two frame units 10, each including first and second plates 12 and 14, and internal segment 16. Reinforcing metal profiles 246 extend through hollow chambers 60 in each of the internal segments 16.

An aluminum glass beading 250 is attached to one of frame units 10, designed to engage pane 244, which is illustrated as a double glazing pane.

In some embodiments, an insulating material 254, such as polyethylene foam, is disposed between profile 101 (and specifically an internal segment thereof) and an edge of pane 244. An additional profile pair 256 is connected to profile 101, for example by screws, and are connected to a friction reducing material 258, which may be disposed, for example, between the door and the floor, as illustrated.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the invention.

1. A method of producing a frame unit, the method comprising the steps of:
(a) sliding a first elongate beam, extending outwardly of a first exterior plate, into a first elongate channel of an internal segment;
(b) compressing two opposing walls of said first elongate channel against said first elongate beam in a direction perpendicular to a longitudinal axis of said first elongate channel, thereby reducing a distance between said two walls of said first elongate channel;
(c) adhering said first exterior plate to said internal segment by heating said first exterior plate and said internal segment until said internal segment is pliably deformed and subsequently cooling said first exterior plate and said internal insert to ambient temperature,
wherein the first exterior plate is formed of a first material, and the internal segment is formed of a second material, different from the first material.

2. The method of claim 1, further comprising the steps of:
(d) sliding a second elongate beam, extending outwardly of a second external plate, into a second elongate channel of said internal segment;
(e) compressing two walls of said second elongate channel against said second elongate beam in a direction perpendicular to a longitudinal axis of said second elongate channel, thereby reducing a distance between said two walls of said second elongate channel; and
(f) adhering said second exterior plate to said internal segment by heating said second exterior plate and said internal insert until said internal segment is pliably deformed and subsequently cooling said second exterior plate and said internal insert to ambient temperature.

3. The method of claim 1, wherein step (b) comprises applying pressure to said two walls of said first elongate channel by rolling a first roller of a pair of rollers along a first side of said first elongate channel, and a second roller of said pair of rollers along a second opposing side of said first elongate channel.

4. The method of claim 2, wherein:
step (b) comprises applying pressure to said two walls of said first elongate channel rolling a first roller of a pair of rollers along a first side of said first elongate channel, and a second roller of said pair of rollers along a second opposing side of said first elongate channel; and
step (e) comprises applying pressure to said two walls of said second elongate channel rolling said first roller of said pair of rollers along a first side of said second elongate channel, and said second roller of said pair of rollers along a second opposing side of said second elongate channel.

5. The method of producing frame units of claim 2, wherein:
step (b) comprises applying pressure to said two walls of said first elongate channel rolling a first roller of a first pair of rollers along a first side of said first elongate channel, and a second roller of said first pair of rollers along a second opposing side of said first elongate channel; and
step (e) is carried out simultaneously with step (b), and step (e) comprises applying pressure to said two walls of said second elongate channel rolling a first roller of a second pair of rollers along a first side of said second elongate channel, and a second roller of said second pair of rollers along a second opposing side of said second elongate channel.

6. The method of claim 2, wherein following completion of steps (b) and (e), said first exterior plate and said second exterior plate are frictionally held in place with respect to said internal segment by static friction of said first and second elongate beams against said respective first and second elgonate channels.

7. The method of claim 2, wherein:
after step (a), said first exterior plate is substantially perpendicular to said internal segment; and
after step (d), said second exterior plate is substantially perpendicular to said internal segment and substantially parallel to said first exterior plate.

8. The method of claim 1, wherein in step (c), said first exterior plate and said internal segment are heated to a temperature greater than at least one of a glass transition temperature and a melting temperature of said second material and lesser than the melting point of said first material.

9. The method of claim 2, wherein step (a) further comprises sliding side walls of said first elongate channel into a first pair of elongate channels, each of said first pair of elongate channel separating said first elongate beam from one of a first pair of elongate walls, said first pair of elongate walls extending outwardly from said first plate on opposing sides of said first elongate beam, and wherein step (b) further comprises pushing said first pair of elongate walls closer to one another.

10. The method of claim 9, wherein, following step (b), each of said first pair of elongate walls are compressed against said side walls of said first elongate channel, such that each of said side walls of said first elongate channel is frictionally engaged by said first elongate beam and by one of said first pair of elongate walls.

11. A method of producing a frame using a plurality of frame units produced according to the method of claim 2, the method comprising the steps of:
(a) diagonally cutting each said frame unit to form two trapezoidal faces, each having a set of parallel edges and at least one sloping edge not perpendicular thereto, and at least one sloping face sharing edges with said trapezoidal faces, all sloping faces being isometric;
(b) abutting the entirety of a said sloping face of each of said frame units to the entirety of a said sloping face of at least one adjacent frame unit, thereby to form at least one contiguous internal hollow bounded by and enclosed within every said internal insert.

12. A frame unit comprising:
first and second exterior plates, each having an elongate beam extending outwardly therefrom, said first and second exterior plates being formed of a first material; and
an internal segment having two elongate channels formed in opposing sides thereof, each of said two elongate channels having one of said elongate beams frictionally secured therein, said internal segment being formed of a second material, different from said first material,
wherein a portion of said internal segment is adhered to each of said first and second exterior plates by heating the frame unit to the glass transition point and/or the melting point of the second material and subsequently allowing said frame unit to cool.

13. The frame unit of claim 12, wherein:
each of said first and second elongate plates further has a pair of elongate walls extending outwardly therefrom on opposing sides said respective elongate beams, each elongate wall of said pair of elongate walls being separated from said respective elongate beam by elongate a secondary elongate channels; and
side walls of each of said elongate channels are frictionally engaged within said secondary elongate channels of said first and second plates.

14. The frame unit of claim 12, wherein:
said first material is a metal, a metalloid, or a metal-alloy; and
said second material is a plastic polymer having a lower melting point and/or glass transition temperature than said first material.

15. The frame unit of claim 14, wherein said first material is aluminum and said second material is polyvinyl chloride (PVC).

16. The frame unit of claim 12, wherein each said elongate channel has two congruent openings disposed at opposing ends of said elongate channel, each said opening having two acute angles, each acute angle formed between two edges bounding said respective opening.

17. The frame unit of claim 12 wherein each said elongate channel has an elongate base and an elongate opening opposite the base, said base being closer to a center of said internal segment than said elongate opening, said base being the widest point of said elongate channel.

18. The frame unit of claim 12, wherein said internal segment includes a plurality of hollow internal chambers, at least one hollow internal chamber accommodating a hollow metal support which abuts walls of said at least one hollow internal chamber.

19. The frame unit of claim 18, wherein at least a subset of said plurality of said hollowed chambers are equal in width and unequal in height.

20. The frame unit of claim 12, wherein said elongate beams of said first and second plates are congruent, and said two elongate channels are congruent.
